(19) United States
(12) Patent Application Publication
(10) Pub. No.: US 2023/0128247 A1
(43) Pub. Date: Apr. 27, 2023

(54) Resistive Skin Element for an Acoustic Panel Intended for an Aircraft

(71) Applicant: Airbus Operations SAS, Toulouse (FR)

(72) Inventors: Florian Ravise, Toulouse (FR); Benoit Przybyla, Toulouse (FR)

(73) Assignee: Airbus Operations SAS, Toulouse (FR)

(21) Appl. No.: 17/964,236

(22) Filed: Oct. 12, 2022

(30) Foreign Application Priority Data
Oct. 25, 2021 (FR) 2111314

(51) Int. Cl. B64C 1/12; B32B 3/26; B32B 5/02; B32B 15/08; B32B 27/28; B32B 7/12; B32B 3/12; B32B 15/02; G10K 11/168; B64F 5/10; B64C 1/40

(52) U.S. Cl. CPC B64C 1/12; B32B 3/266; B32B 5/028; B32B 15/08; B32B 27/285; B32B 7/12; B32B 3/12; B32B 15/02; B32B 27/281; G10K 11/168; B64F 5/10; B64C 1/40; B32B 2307/102; B32B 2605/18

(57) ABSTRACT

A resistive skin element for an acoustic panel intended for an aircraft includes a first ply, a second ply with openings and a wire mesh which is sandwiched between the two plies. First ply includes at least one layer made of C/PEAK and a film made of PEI. Second ply includes at least one layer made of PEI First ply is crossed by perforations. Second ply has openings configured so that second ply does not obstruct the perforations of first ply. The wire mesh allows perforations with large sizes to be made while keeping good acoustic properties.

### FIELD OF THE INVENTION

The present invention relates to a resistive skin element for an acoustic panel intended for an aircraft, in particular a transport airplane.

### BACKGROUND OF THE INVENTION

It is known that, on an aircraft, for example on a transport airplane, significant noise is often generated, notably by the propulsive assemblies or jet engines of the aircraft. To reduce the noise effect produced by the jet engines of the aircraft, it is known practice to provide, in particular on the nacelles of the jet engines, walls provided with panels offering good acoustic absorption. Usually, an acoustic attenuation panel, hereinafter called acoustic panel, generally comprises an acoustic structure. This acoustic structure often comprises a cellular structure, in particular a honeycomb structure, and is provided on both of its faces, respectively, with an acoustic skin also called resistive skin or resistive layer that is perforated, and with a backing skin or backing layer that is not perforated. The acoustic panel is arranged so that the acoustic skin is situated in proximity to the noise source, notably upstream and/or downstream of the fan in the case of an aircraft jet engine, to provide effective absorption of the noise generated upstream and downstream of the fan.

Generally, the resistive skin is thermoformed before being perforated to satisfy the acoustic demands. To satisfy the aerodynamic demands, in order to have minimal drag, the size of the perforations to be produced is generally between 0.4 mm and 1 mm, preferably less than 0.5 mm. This perforation size can be a problem on an industrial scale because of the number of perforations to be produced and the drilling rate. This can have an influence on the quality of the perforations.

### BRIEF SUMMARY OF THE INVENTION

An aspect of the invention relates to a resistive skin element for an acoustic panel intended for an aircraft, in particular a transport airplane, which mitigates this drawback.

According to an embodiment of the invention, the resistive skin element comprises:

a first ply comprising at least:
a layer made of C/PEAK,
a first film made of PEI applied onto a first face of the layer made of C/PEAK;
a second ply with openings comprising at least one first layer made of PEI;
a wire mesh sandwiched between the first ply and the second ply in such a way that the first film made of PEI of the first ply faces the wire mesh;
   the first ply being crossed by perforations,
   the second ply having openings configured so that the second ply does not block the perforations of the first ply.

Thus, by virtue of the wire mesh, it is possible to produce perforations of sizes greater than that of the prior art in order to obtain a low drag similar to that obtained with perforations of smaller size, while obtaining a desired acoustic permeability and mechanical demand.

According to one embodiment, the first ply comprises a second film made of PEI applied onto a second face of the layer made of C/PEAK.

According to another embodiment, the first layer made of PEI of the second ply corresponds to a first film made of PEI, the second ply further comprises a layer made of C/PEAK having a first face onto which is applied the first film made of PEI of the second ply such that the first film made of PEI of the second ply faces the wire mesh.

According to another embodiment, the second ply further comprises a second film made of PEI applied onto a second face of the layer made of C/PEAK of the second ply.

According to another embodiment, the first layer made of PEI of the second ply corresponds to a layer made of C/PEI.

According to another embodiment, the first layer made of PEI of the second ply corresponds to a first film made of PEI, the second ply further comprising a layer made of C/PEI and a second film made of PEI, the layer made of C/PEI being sandwiched between the first film made of PEI and the second film made of PEI.

The invention also relates to an acoustic panel intended for an aircraft. According to an embodiment of the invention, the acoustic panel comprises:
at least one resistive skin element as specified above, the resistive skin element or elements being assembled to form a set of resistive skin elements,
a band applied onto the second ply,
an adhesive layer applied onto the band,
   a honeycomb layer applied onto the adhesive layer.

The invention also relates to a propulsive device for an aircraft.

According to an embodiment of the invention, the propulsive device comprises at least one acoustic panel as specified above.

The invention also relates to an aircraft comprising at least one acoustic panel as specified above.

The invention also relates to a method for manufacturing a resistive skin element for an acoustic panel intended for an aircraft.

According to an aspect of the invention, the method comprises a first series of steps for forming a first ply, the first series of steps comprising at least:
a first step of providing a layer made of unconsolidated C/PEAK,
a step of application of a first film made of PEI onto a first face of the layer made of C/PEAK,
a step of consolidation and of shaping of the layer made of C/PEAK,
a step of perforation of the first ply consisting in creating perforations through the first ply; the method further comprising a second series of steps for forming a second ply, the second series of steps comprising at least:
a step of providing a first layer made of unconsolidated PEI, the first layer made of PEI comprising openings;
   the method further comprises a third series of steps for forming the resistive skin element, the third series of steps comprising at least:
a step of providing a wire mesh,
a step of application of a first face of the wire mesh onto the first layer made of PEI of the first ply,
a step of application of the second ply onto a second face of the wire mesh,
   a step of consolidation of an assembly comprising the first ply, the second ply and the wire mesh.

According to one embodiment, the first series of steps further comprises:
a step of application of a second film made of PEI onto a second face of the layer made of C/PEAK, said application step preceding at least the consolidation and shaping step and the perforation step.

According to another embodiment, the second series of steps further comprises:
a step of providing a layer made of C/PEAK,
a step of application of the first layer made of PEI onto a first face of the layer made of C/PEAK, the first layer made of PEI of the second ply corresponding to a first film made of PEI,
a step of application of the assembly comprising the layer made of C/PEAK and the first film made of PEI onto the wire mesh such that the first film made of PEI of the second ply faces the wire mesh.

According to another embodiment, the second series of steps further comprises:
a step of application of a second film made of PEI onto a second face of the layer made of C/PEAK of the second ply.

According to another embodiment, the first layer made of PEI of the second ply corresponds to a layer made of C/PEI.

According to another embodiment, the second series of steps further comprises:
a step of providing a layer made of C/PEI,
a step of application of the first layer made of PEI onto a first face of the layer made of C/PEI, the first layer made of PEI corresponding to a first film made of PEI,
step of application of a second film made of PEI onto a second face of the layer made of C/PEI.

### BRIEF DESCRIPTION OF THE DRAWINGS

The attached figures will give a good understanding of how the invention can be produced. In these figures, identical references denote similar elements.

FIG. 1 schematically represents an exploded transverse cross section of an embodiment of the resistive skin element.

FIG. 2 schematically represents an embodiment of the first ply.

FIG. 3 schematically represents an exploded transverse cross section of another embodiment of the resistive skin element.

FIG. 4 schematically represents an exploded transverse cross section of another embodiment of the resistive skin element.

FIG. 5 schematically represents an exploded transverse cross section of another embodiment of the resistive skin element.

FIG. 6 schematically represents an exploded transverse cross section of another embodiment of the resistive skin element.

FIG. 7 schematically represents an exploded transverse cross section of another embodiment of the resistive skin element.

FIG. 8 represents a perspective view of an embodiment of the resistive skin element.

FIG. 9 represents a top view of a portion of an embodiment of the resistive skin element.

FIG. 10a and FIG. 10b respectively represent a perspective view of a shaped resistive skin element and a perspective view of a resistive skin comprising a plurality of resistive skin elements assembled together.

FIG. 11 schematically represents a transverse cross section of a portion of an acoustic panel.

FIG. 12 represents by a block diagram the method for manufacturing a resistive skin element according to an embodiment.

FIG. 13 represents by a block diagram an embodiment of the first series of steps for forming the first ply of the method for manufacturing a resistive skin element.

FIG. 14 represents by a block diagram an embodiment of the second series of steps for forming the second ply of the method for manufacturing a resistive skin element.

FIG. 15 represents by a block diagram an embodiment of the second series of steps for forming the second ply of the method for manufacturing a resistive skin element.

FIG. 16 represents by a block diagram an embodiment of the method for manufacturing an acoustic panel.

FIG. 17 represents a top view of an aircraft comprising a propulsive system comprising acoustic panels provided with acoustic skin elements.

### DETAILED DESCRIPTION

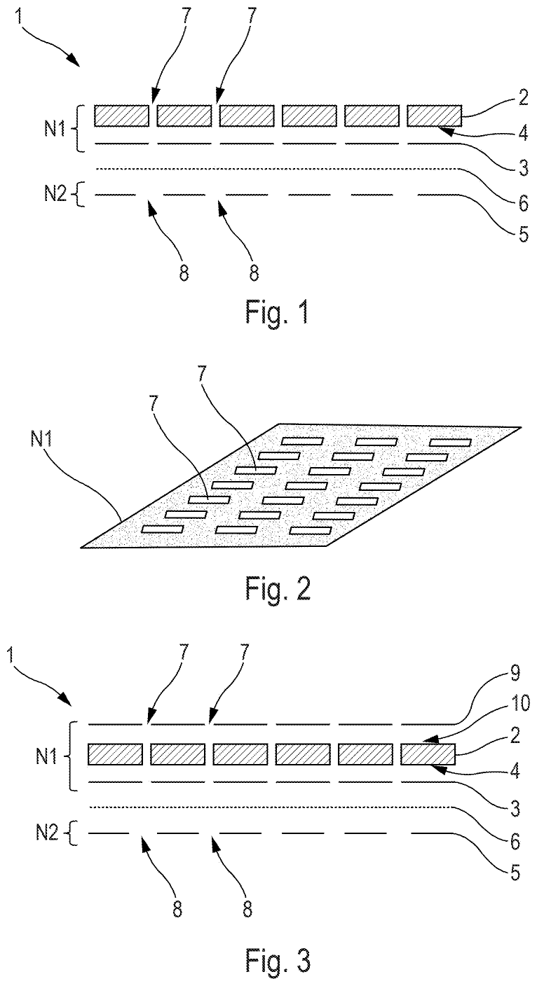

FIG. 1 and FIG. 3 to FIG. 7 represent several embodiments of a resistive skin element 1 for an acoustic panel 21 intended for an aircraft AC.

An acoustic panel 21 for a propulsive device P is usually of a generally tapered form. The resistive skin 17 also has a generally tapered form as represented in FIG. 10b. The resistive skin element 1 can therefore have a frustoconical segment form as represented in FIG. 10a.

The resistive skin element 1 comprises two thermoplastic materials having different melting points, notably a resin from the family of carbon fiber-reinforced polyaryletherketones and a resin of polyetherimide optionally reinforced with carbon fibers. The family of polyaryletherketones comprises the polyetheretherketone resin PEEK, the polyetherketoneketone resin PEKK, etc. The carbon fibers can be replaced by glass fibers or a mixture of carbon fibers and of glass fibers. Hereinafter in the description, only carbon fibers will be mentioned, but it is understood that these carbon fibers can therefore be replaced by glass fibers or a mixture of carbon fibers and of glass fibers.

Hereinafter in the description, the resin from the family of the carbon fiber-reinforced polyaryletherketones and the carbon fiber-reinforced polyetherimide resin will be called C/PEAK and C/PEI, respectively.

Likewise, the resin from the family of the polyaryletherketones and the polyetherimide resin will be called PEAK and PEI, respectively.

PEI is miscible in PEAK at a consolidation temperature of between 290° C. and 300° C. The melting of the PEAK occurs at a temperature of 342° C. with a consolidation temperature of between 390° C. and 400° C.

The resistive skin element 1 comprises a ply N1, a ply N2 and a wire mesh 6.

As represented in FIG. 1, the ply N1 comprises at least one layer made of C/PEAK 2 and a film made of PEI 3 applied onto a face 4 of the layer made of C/PEAK 2. The ply N1 is crossed by perforations 7. The size of the perforations 7 depends on an acoustic permeability desired for the acoustic panel 21 and/or on desired mechanical performance levels. FIG. 2 represents an example of ply N1 comprising perforations 7. In this example, the perforations 7 have a rectangular form.

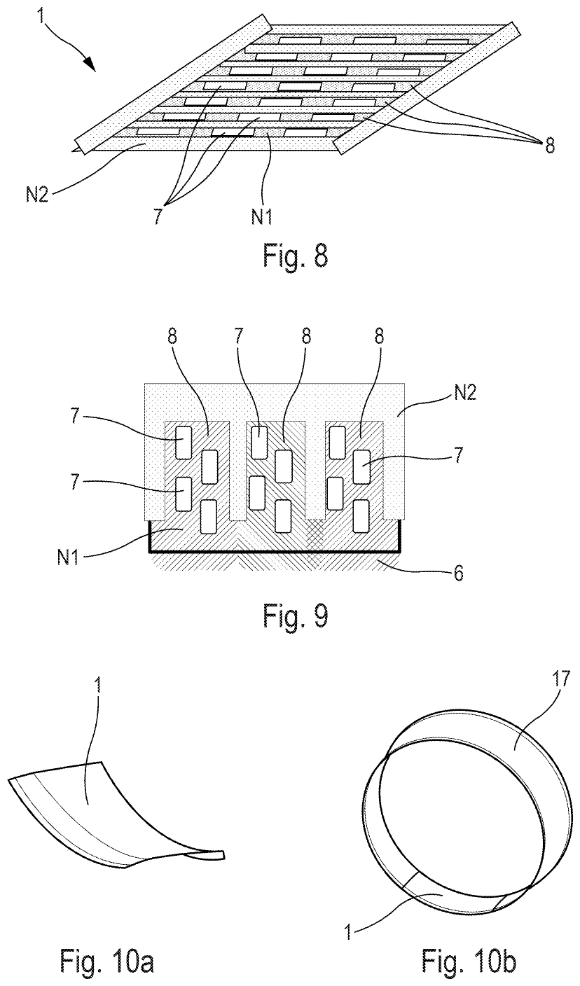

The ply N2 corresponds to a ply N2 with openings comprising at least one layer made of PEI 5. The ply N2 with openings has openings 8 configured so that the ply N2 does not block the perforations 7 of the ply N1. FIG. 8 represents a ply N2 disposed on a ply N1. The openings 8 of the ply N2 can correspond to elongate openings over an entire width or length of the ply N2. The ply N2 can thus correspond to a grid as represented in FIG. 8. FIG. 9 represents a detail of the ply N2 disposed on the ply N1. In this FIG. 9, it can be seen that the perforations 7 of the ply N1 are not blocked by the ply N2. Each of the perforations 7 of the ply N1 emerges fully on an opening 8 of the ply N2. In other words, no solid part of the ply N2 forms an obstacle to the perforations 7 of the ply N1 in line with each of these perforations 7. This allows the resistive skin element 1 to obtain the acoustic permeability desired for the acoustic panel 21 and/or the mechanical performance levels desired for the acoustic panel 21. An even partial overlap of these perforations 7 by the solid parts of the ply N2 can degrade said desired acoustic permeability and/or said desired mechanical performance levels.

The wire mesh 6 is sandwiched between the ply N1 and the ply N2 in such a way that the film made of PEI 3 of the ply N1 faces the wire mesh 6.

The wire mesh 6 can comprise several woven parts (or woven patches) in order to facilitate the placement of the wire mesh 6 on the ply N1 when said ply N1 is consolidated. The set of the woven parts then forms the wire mesh 6. The woven parts can be joined edge-to-edge or by overlaying of the edges in joining zones. In order to form the wire mesh 6, the joining zones between the woven parts are sandwiched between the ply N1 and the ply N2 in such a way that the perforations 7 of the ply N1 and the openings 8 of the ply N2 are not in line with said joining zones of the wire mesh 6.

The wire mesh 6 can be made of metal. The wire mesh 6 can also be made of polymer. By way of example, the wire mesh 6 can be made of PEAK. Preferably, the polymer has a melting point greater than that of the C/PEI.

According to an embodiment represented in FIG. 3, the ply N1 comprises a film made of PEI 9 applied onto a face 10 of the layer made of C/PEAK 2, opposite the face 4.

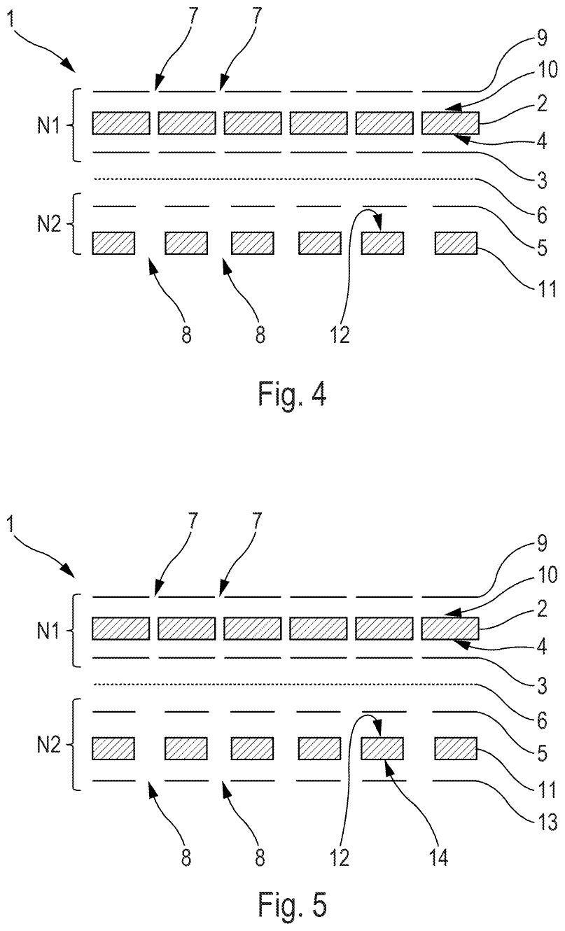

According to an embodiment represented in FIG. 4, the layer made of PEI 5 of the ply N2 corresponds to a film made of PEI. The ply N2 then further comprises a layer made of C/PEAK 11 having a face 12 onto which said film made of PEI 5 of the ply N2 is applied in such a way that the film made of PEI 5 of the ply N2 faces the wire mesh 6.

According to an embodiment represented in FIG. 5, the ply N2 further comprises a film made of PEI 13 applied onto a face 14 of the layer made of C/PEAK 11 of the ply N2, opposite the face 12.

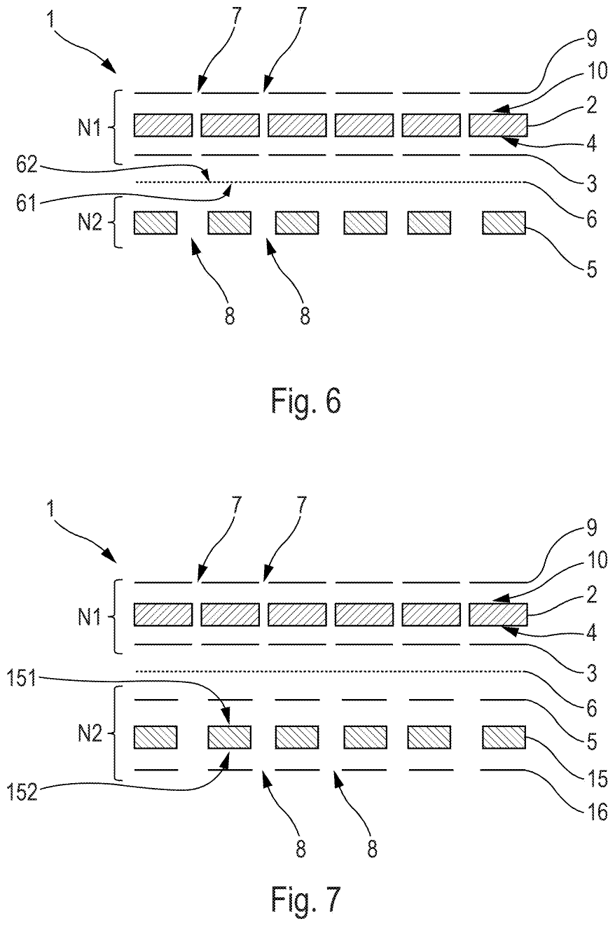

According to an embodiment represented in FIG. 6, the layer made of PEI 5 of the ply N2 is reinforced with carbon fibers. In this embodiment, the layer made of PEI 5 therefore corresponds to a layer made of C/PEI.

According to a preferred embodiment represented in FIG. 7, the layer made of PEI 5 of the ply N2 corresponds to a film made of PEI. The ply N2 then further comprises a layer made of C/PEI 15 and a film made of PEI 16. The layer made of PEI 5 is sandwiched between the film made of PEI 5 and the film made of PEI 16. The layer made of PEI 16 allows the adhesion of a thermosetting material, such as the band 18 which is explained hereinbelow.

The film made of PEI 5 of the ply N2 allows a good assembly with the ply N1 comprising the layer made of C/PEAK 2 at the time of consolidation.

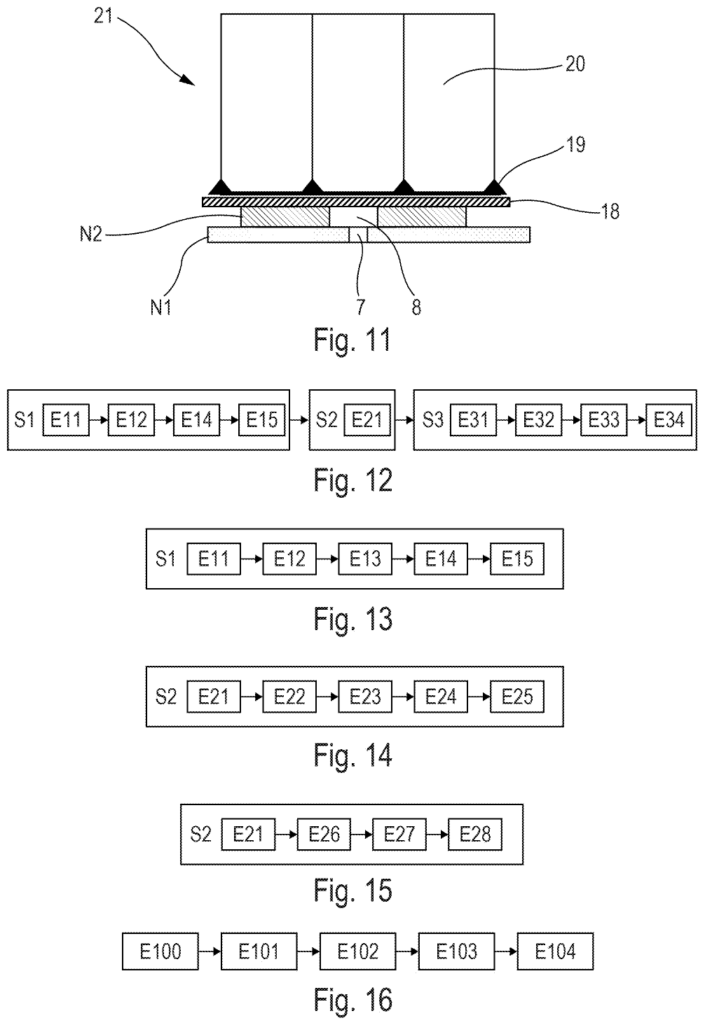

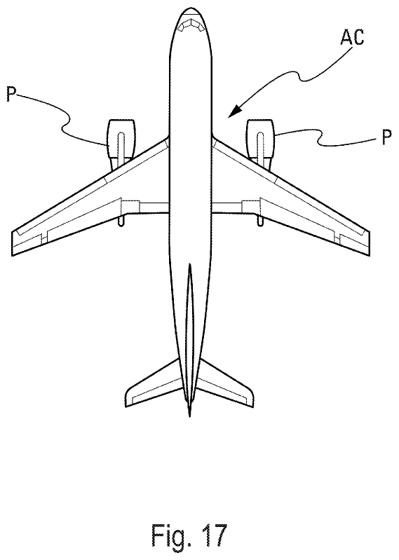

The invention also relates to an acoustic panel 21 intended for an aircraft AC. FIG. 11 represents a portion of an acoustic panel 21.

The acoustic panel 21 comprises at least one resistive skin element 1 according to the invention. The resistive skin element or elements 1 are assembled to form the resistive skin 17 of the acoustic panel 21.

The acoustic panel further comprises a band 18 applied onto the ply N2, an adhesive layer 19 applied onto the band 18 and a honeycomb layer 20 applied onto the adhesive layer 19. The band 18 is applied onto the parts of the ply N2 without blocking the openings 8 of the ply N2.

The band 18 can be made of a thermosettable material.

In a nonlimiting manner, the films made of PEI 3, 9, 13 and 16 have a thickness lying within a range of between 25 μm and 150 μm, preferably within a range between 80 μm and 100 μm, advantageously equal to 90 μm. Likewise, in the embodiments (FIGS. 4 and 7) in which the layer made of PEI 5 corresponds to a film made of PEI, the film made of PEI 5 has a thickness lying within a range between 25 μm and 150 μm, preferably within a range between 80 μm and 100 μm, advantageously equal to 90 μm.

The invention also relates to a propulsive device P for an aircraft AC. The propulsive device P comprises at least one acoustic panel 21 according to the invention.

The invention also relates to an aircraft AC comprising at least one acoustic panel 21 according to the invention.

The invention also relates to a method for manufacturing the resistive skin element 1 for an acoustic panel 21 intended for an aircraft AC.

As represented in FIG. 12 and in FIG. 1, the method comprises a series of steps S1 for forming the ply N1, a series of steps S2 for forming the ply N2 and a series of steps S3 for forming the resistive skin element 1.

The series of steps S1 comprises at least:
a step E11 of providing the layer made of unconsolidated C/PEAK 2,
a step E12 of application of the film made of PEI 3 onto the face 4 of the layer made of C/PEAK 2,
a step E14 of consolidation and of shaping of the layer made of C/PEAK 2,
a step E15 of perforation of the ply N1 consisting in creating perforations 7 through the ply N1.

The perforations 7 have a size which depends on an acoustic permeability desired for the acoustic panel 21 and/or on desired mechanical performance levels.

The consolidation and shaping step E14 can be performed, for example in a press, at a temperature of between 390° C. and 400° C. The consolidation can comprise roll-bonding in addition to the consolidation.

The ply N1 comprising the layer made of C/PEAK is therefore preformed, consolidated and perforated in advance. The three operations can be performed in parallel, which creates a time saving in the manufacturing of the resistive skin element 1.

The series of steps S2 comprises at least one step E21 of providing the layer made of unconsolidated PEI 5. The layer made of PEI 5 comprises openings 8.

The series of steps S3 comprises at least:
a step E31 of providing the wire mesh 6,
a step E32 of application of the face 62 of the wire mesh 6 onto the film made of PEI 3 of the ply N1,
a step E33 of application of the ply N2 onto the face 61 of the wire mesh 6,
a step E34 of consolidation of an assembly comprising the ply N1, the ply N2 and the wire mesh 6.

The application step E32 makes it possible to shape the wire mesh 6 on the ply N1 which is already consolidated. This makes it possible to facilitate the application of the wire mesh 6 for its encapsulation between the ply N1 and the ply N2.

The consolidation can comprise a roll-bonding in addition to the consolidation. The consolidation step E34 can be performed, for example in a press, at a temperature of between 290° C. and 300° C. to allow co-consolidation between the ply N1 and the ply N2. A pressure of between 1 bar and 100 bar can be exerted to obtain an adequate quality of the resistive skin element 1. The wire mesh 6 is thus encapsulated between the ply N1 and the ply N2 after the consolidation of the consolidation step E34. Since the melting point of the PEAK is greater than the melting point of the PEI, the consolidation at a temperature of between 290° C. and 300° C. does not affect the ply N1 which is already consolidated. Thus, this makes it possible to maintain a geometrical form which ensures the acoustic properties desired for the resistive skin element 1, because the ply N1 comprising the layer made of C/PEAK is not deconsolidated by the consolidation step E34. Through the use of C/PEAK, the layer made of C/PEAK does not migrate toward the perforations 7 that have already been made. Furthermore, there is also not any deformation of the ply N1, or degradation of the material from which the ply N1 is manufactured.

As represented in FIG. 13 for the embodiment represented in FIG. 3, the series of steps S1 further comprises a step E13 of application of the film made of PEI 9 onto the face 10 of the layer made of C/PEAK 2. This application step E13 precedes at least the consolidation and shaping step E14 and the perforation step E15.

As represented in FIG. 14 for the embodiment represented in FIG. 4, the series of steps S2 further comprises:
a step E22 of providing the layer made of C/PEAK 11,
a step E23 of application of the layer made of PEI 5 onto the face 12 of the layer made of C/PEAK 11, the layer made of PEI 5 of the ply N2 corresponding to a film made of PEI,
a step E24 of application of the assembly comprising the layer made of C/PEAK 11 and the film made of PEI 5 onto the wire mesh 6 in such a way that the film made of PEI 5 of the ply N2 faces the wire mesh 6.

As represented in FIG. 14 for the embodiment represented in FIG. 5, the series of steps S2 further comprises a step E25 of application of the film made of PEI 13 onto the face 14 of the layer made of C/PEAK 11 of the ply N2.

As represented in FIG. 6, the layer made of PEI 5 of the ply N2 can correspond to a layer made of C/PEI.

As represented in FIG. 15 for the embodiment represented in FIG. 7, the series of steps S2 further comprises:
a step E26 of providing the layer made of C/PEI 15,
a step E27 of application of the layer made of PEI 5 onto the face 151 of the layer made of C/PEI 15, the layer made of PEI 5 corresponding to a film made of PEI,
a step E28 of application of the film made of PEI 16 onto the face 152 of the layer made of C/PEI 15.

The ply N2 can be produced beforehand by an injection method or by a hand or contact lay-up molding method before being applied onto the wire mesh 6. It can also be performed by surjection directly onto the wire mesh 6 with the PEI or the C/PEI in order to shape the ply N2 directly on the already consolidated ply N1.

The invention also relates to a method for manufacturing an acoustic panel 21 intended for an aircraft AC.

As represented in FIG. 16, the method comprises the following steps:
a step E100 of assembly of a plurality of resistive skin elements 1 manufactured according to the invention,
a step E101 of application of at least one band 18 onto the ply N2,
a step E102 of application of an adhesive layer 19 onto the band 18,
a step E103 of application of a honeycomb layer 20 onto the adhesive layer 19,
a step E104 of crosslinking of the adhesive layer 19.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A resistive skin element for an acoustic panel intended for an aircraft,
comprising:
a first ply comprising at least:
a layer made of C/PEAK,
a first film made of PEI applied onto a first face of the layer made of C/PEAK;
a second ply with openings comprising at least one first layer made of PEI;
a wire mesh sandwiched between the first ply and the second ply so that the first film made of PEI of the first ply faces the wire mesh;
wherein the first ply is crossed by perforations, and
wherein the second ply having openings is configured so that the second ply does not block the perforations of the first ply.

2. The resistive skin element as claimed in claim 1,
wherein the first ply comprises a second film made of PEI applied onto a second face of the layer made of C/PEAK.

3. The resistive skin element as claimed in claim 1,
wherein the first layer made of PEI of the second ply corresponds to a first film made of PEI, and
wherein the second ply further comprises a layer made of C/PEAK having a first face onto which is applied the first film made of PEI of the second ply so that the first film made of PEI of the second ply faces the wire mesh.

4. The resistive skin element as claimed in claim 1,
wherein the second ply further comprises a second film made of PEI applied onto a second face of the layer made of C/PEAK of the second ply.

5. The resistive skin element as claimed in claim 1,
wherein the first layer made of PEI of the second ply corresponds to a layer made of C/PEI.

6. The resistive skin element as claimed in claim 1,
wherein the first layer made of PEI of the second ply corresponds to a first film made of PEI, and
wherein the second ply further comprises a layer made of C/PEI and a second film made of PEI, the layer made of C/PEI being sandwiched between the first film made of PEI and the second film made of PEI.

7. An acoustic panel configured for an aircraft, comprising:
at least one resistive skin element as claimed in claim 1, the resistive skin element or elements assembled to form a set of resistive skin elements,
a band applied onto the second ply,
an adhesive layer applied onto the band, and
a honeycomb layer applied onto the adhesive layer.

8. A propulsive device for an aircraft,
comprising at least one acoustic panel as claimed in claim 7.

9. An aircraft
comprising at least one acoustic panel as claimed in claim 7.

10. A method for manufacturing a resistive skin element for an acoustic panel configured for an aircraft,
comprising a first series of steps for forming a first ply, the first series of steps comprising at least:
providing a layer made of unconsolidated C/PEAK,
applying a first film made of PEI onto a first face of the layer made of C/PEAK,
consolidating and shaping the layer made of C/PEAK, and
perforating the first ply including creating perforations through the first ply;
the method further comprising a second series of steps for forming a second ply, the second series of steps comprising at least:
providing a first layer made of unconsolidated PEI, the first layer made of PEI comprising openings;
the method further comprising a third series of steps for forming the resistive skin element, the third series of steps comprising at least:
providing a wire mesh,
applying a first face of the wire mesh onto the first layer made of PEI of the first ply,
applying the second ply onto a second face of the wire mesh, and
consolidating an assembly comprising the first ply, the second ply and the wire mesh.

11. The method as claimed in claim 10,
wherein the first series of steps further comprises:
applying a second film made of PEI onto a second face of the layer made of C/PEAK, said application step preceding at least the consolidation and shaping step and the perforation step.

12. The method as claimed in claim 10,
wherein the second series of steps further comprises:
providing a layer made of C/PEAK,
applying the first layer made of PEI onto a first face of the layer made of C/PEAK, the first layer made of PEI of the second ply corresponding to a first film made of PEI, and
applying the assembly comprising the layer made of C/PEAK and the first film made of PEI onto the wire mesh so that the first film made of PEI of the second ply faces the wire mesh.

13. The method as claimed in claim 10,
wherein the second series of steps further comprises:
applying a second film made of PEI onto a second face of the layer made of C/PEAK of the second ply.

14. The method as claimed in claim 10,
wherein the first layer made of PEI of the second ply corresponds to a layer made of C/PEI.

15. The method as claimed in claim 10,
wherein the second series of steps further comprises:
providing a layer made of C/PEI,
applying the first layer made of PEI onto a first face of the layer made of C/PEI, the first layer made of PEI corresponding to a first film made of PEI, and
applying a second film made of PEI onto a second face of the layer made of C/PEI.

16. A method for manufacturing an acoustic panel configured for an aircraft,
comprising the following steps:
assembling a plurality of resistive skin elements manufactured as claimed in claim 10,
applying at least one band onto the second ply,
applying an adhesive layer onto the band,
applying a honeycomb layer onto the adhesive layer, and
crosslinking the adhesive layer.
